(19) United States
(12) Patent Application Publication
(10) Pub. No.: US 2016/0121823 A1
(43) Pub. Date: May 5, 2016

(54) Controlling Automotive Vehicle Powertrain, Drivetrain Suspension Components and Accessories Using Portable Personal Electronic Telecommunication Devices

(71) Applicant: American Axle & Manufacturing, Inc., Detroit, MI (US)

(72) Inventors: Chad R. Umscheid, Oxford, MI (US); John C. Hibbler, Lake Orion, MI (US); Gregory A. Marsh, Ferndale, MI (US)

(21) Appl. No.: 14/881,894

(22) Filed: Oct. 13, 2015

Related U.S. Application Data
(60) Provisional application No. 62/073,404, filed on Oct. 31, 2014.

(51) Int. Cl. B60R 16/023; F16H 61/02; B60G 21/055; F16H 48/34

(52) U.S. Cl. CPC B60R 16/0231; F16H 48/34; F16H 61/0202; B60G 21/055; F16H 2048/204

(57) ABSTRACT

The circuit controls powertrain, drivetrain, vehicle suspension and accessory components of an automotive vehicle to programmatically provide different drive and handling performance using a portable personal electronic telecommunication device having memory and a processor. The circuit includes a protocol converter circuit coupled to receive electric power from an electrical power system of the automotive vehicle, and has at least one port to electrically couple to at least one actuator that supplies control to the controlled component of the automotive vehicle. The protocol converter circuit provides a communication channel by which communication is established with a portable personal electronic telecommunication device. An executable program stored in the memory circuit and operated by the processor of the portable personal electronic telecommunication device supplies control signals via the protocol converter circuit to the one or more actuators, thereby programmatically providing different vehicle drive and handling performances.

### CROSS-REFERENCE TO RELATED APPLICATIONS

This application claims the benefit of U.S. Provisional Application No. 62/073,404, filed on Oct. 31, 2014. The entire disclosure of the above application is incorporated herein by reference.

### FIELD

This disclosure relates generally to the control of automotive vehicle drivetrain, powertrain, suspension components and accessories. More particularly the disclosure relates to effecting such control using portable personal electronic telecommunication devices, such as smartphones and tablet computers.

### BACKGROUND

Although rarely found in passenger cars, some sport utility vehicles and light trucks can be purchased with variety of different powertrain, drivetrain and suspension options that make those vehicles better suited for rugged off-road use. Original equipment manufacturers of these off-road capable vehicles must necessarily make certain equipment choices to meet fuel economy and pricing requirements. Thus an off-road driving enthusiast may simply not be able to purchase an original equipment vehicle that has the precise complement of components he or she desires.

That is where the aftermarket comes in. Owners of original equipment vehicles can replace stock powertrain, drivetrain and suspension components with more off-road capable components. Many of these can be electrically switched between different modes: one suitable for around-town driving and another suitable for off-road use.

One problem with installing aftermarket components is that the vehicle dashboard is not so easily customized. If special switches are needed to control the aftermarket components, these typically need to be bolted on under the dashboard or otherwise installed in a manner that defaces the look of the original vehicle interior, there by damaging resale value.

### SUMMARY

The disclosed system takes a fresh approach to the problem of how to retrofit an automotive vehicle with aftermarket powertrain, drivetrain and suspension components. Through the deployment of a protocol converter circuit board, the disclosed system allows these aftermarket powertrain, drivetrain and suspension components, as well as associated accessories such as electric winches, light bars, vehicle lift devices and the like, to be controlled using a portable personal electronic telecommunication device, such as a smartphone or tablet computer.

The disclosed system goes further, however, by providing a system that will programmatically provide the user with a selectable range of different driving experience packages, all at the touch of a button. The disclosed system leverages both vehicle mounted sensors and native sensors within the portable personal electronic telecommunication device to provide a degree of control that has not heretofore been practical. The disclosed system thus opens up many driving experience possibilities that were not heretofore available through aftermarket retrofit.

For example, in one embodiment the disclosed system is able to utilize GPS and/or accelerometer sensors within the portable device to implement a lockout mechanism that inhibits certain off-road features from being used or engaged above a certain speed limit. In another embodiment, the GPS sensor data from the portable device is used as a form of geofencing, whereby a preprogrammed driving experience is automatically deployed, or recommended for deployment, when the vehicle is in a particular geographic location. Weather data obtained from sensors and data connections provided by the portable device can also be used to automatically deploy, or recommend for deployment, the driving experience setting that is appropriate for the sensed weather conditions. Tilt sensors and/or inertial sensors provided by the portable device can also be used to automatically deploy, or recommend for deployment, a driving experience to ensure best vehicle performance when the system detects the vehicle is ascending or descending at steep angles or traveling on non-level terrain.

Therefore, according to one aspect the disclosure describes a circuit for adapting at least one of the powertrain, drivetrain and vehicle suspension components of an automotive vehicle to be controlled by a portable personal electronic telecommunication device having memory and a processor. The circuit includes a protocol converter circuit coupled to receive electric power from an electrical power system of the automotive vehicle, the protocol converter circuit having at least one port by which to electrically couple to at least one actuator that supplies control to a powertrain, drivetrain or vehicle suspension component of the automotive vehicle. The protocol converter circuit further provides a communication channel by which communication is established with a portable personal electronic telecommunication device. An executable program, stored in the memory circuit of the portable personal electronic telecommunication device and operable by the processor of the portable personal electronic telecommunication device, supplies control signals via the protocol converter circuit to said at least one actuator.

According to another aspect, the executable program, stored in the memory circuit of the portable personal electronic telecommunication device and operable by the processor of the portable personal electronic telecommunication device, supplies control signals via the protocol converter circuit to plural different actuators in harmony or in concert to programmatically provide different drive and handling performance of the vehicle.

In yet another aspect, the protocol converter circuit provides a communication channel by which communication is established with a portable personal electronic telecommunication device; and the executable program processes signals from at least one inertial or guidance sensor and supplies control signals via the protocol converter circuit the at least one actuator based on said signals from the at least one inertial sensor or guidance sensor.

In still another aspect, the executable program processes signals from at least one inertial or guidance sensor and supplies control signals via the protocol converter circuit to at least one actuator based on said signals from the inertial or guidance sensor and further based on said vehicle powered sensor.

In a further aspect, the executable program processes signals from at least one inertial or guidance sensor and from a vehicle powered sensor: (a) to generate a first location datum, (b) to supply predefined control signals via the protocol converter circuit to the at least one actuator and (c) to store in said memory a record that associates said predefined control signals with the first location datum. The executable program is then operable by the processor to read from said memory the stored record that associates the predefined control signals with the first location datum and to use that stored record to supply additional control signals via the protocol converter circuit the at least one actuator.

### BRIEF DESCRIPTION OF THE DRAWINGS

FIG. 1 is a perspective view of an exemplary off-road vehicle, showing some of the components controlled by the electronic control system;

FIG. 2 is a block diagram of a first embodiment of electronic control system;

FIG. 3 is a block diagram of a second embodiment of electronic control system;

FIG. 4 is a block diagram of a WiFi electronic control circuit useful to support communication with both bus-connected devices and non-bus-connected devices;

FIG. 5 is a flowchart diagram depicting how the gateway device is programmed to function as a protocol converter

FIG. 6 is an exemplary user interface display on a portable device;

FIG. 7 is a block diagram illustrating at a top level how the executable program is configured;

FIGS. 8A, 8B and 8C are flowchart diagrams depicting how the executable program stored in the memory circuit of the portable personal electronic telecommunication device and operable by the processor of the portable personal electronic telecommunication device is configured to process signals.

### DESCRIPTION OF PREFERRED EMBODIMENTS

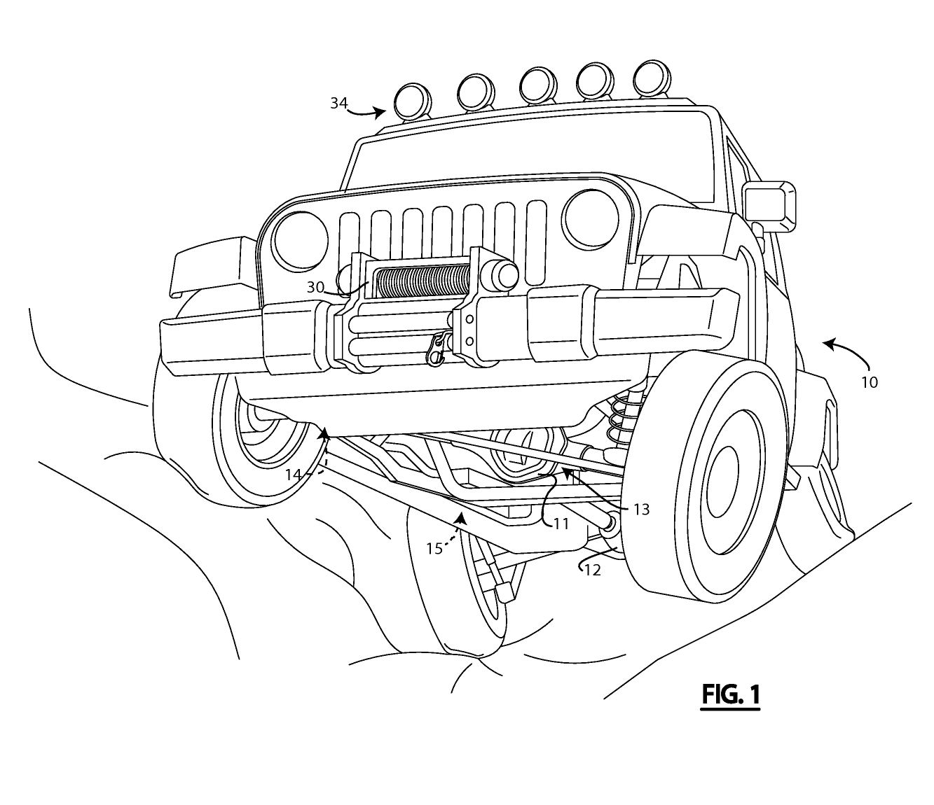

Referring to FIG. 1, an exemplary off-road vehicle is illustrated at 10. As shown the vehicle 10 is driving across extremely rough terrain, requiring an arsenal of special powertrain, drivetrain and suspension components, such as a front locking differential 11, a rear locking differential 12, a transfer case 13, a front disconnectable stabilizer bar 14 and a rear disconnectable stabilizer bar 15. In addition, the vehicle has been equipped with an electric winch 30 that may be used to pull the vehicle 10 out of a rut, as needed. The vehicle 10 has also been equipped with a lift mechanism 32 that may be used to lift the vehicle chassis a sufficient distance above the ground to help disengage the vehicle 10 when it becomes stuck on an object, such as a large rock. A light bar 34 has also been installed to the vehicle 10 and is selectively operable to provide improved nighttime visibility.

Each of these described components is coupled to the electronic control system, allowing each component to be operated, individually or in tandem, by a portable personal electronic telecommunication device, programmed to utilize the executable program stored in the memory circuit of the device as will be described.

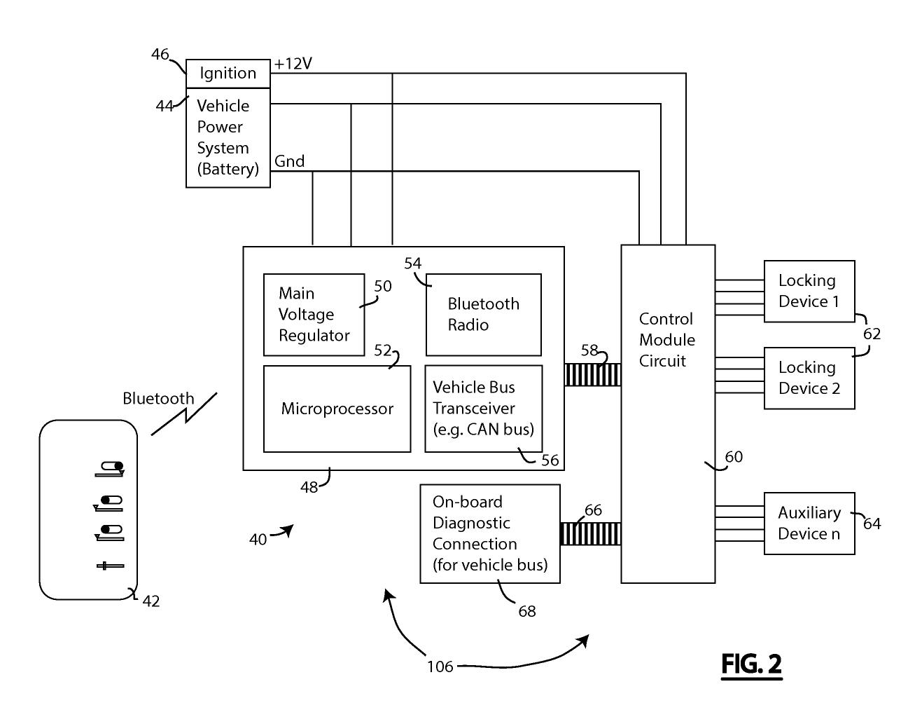

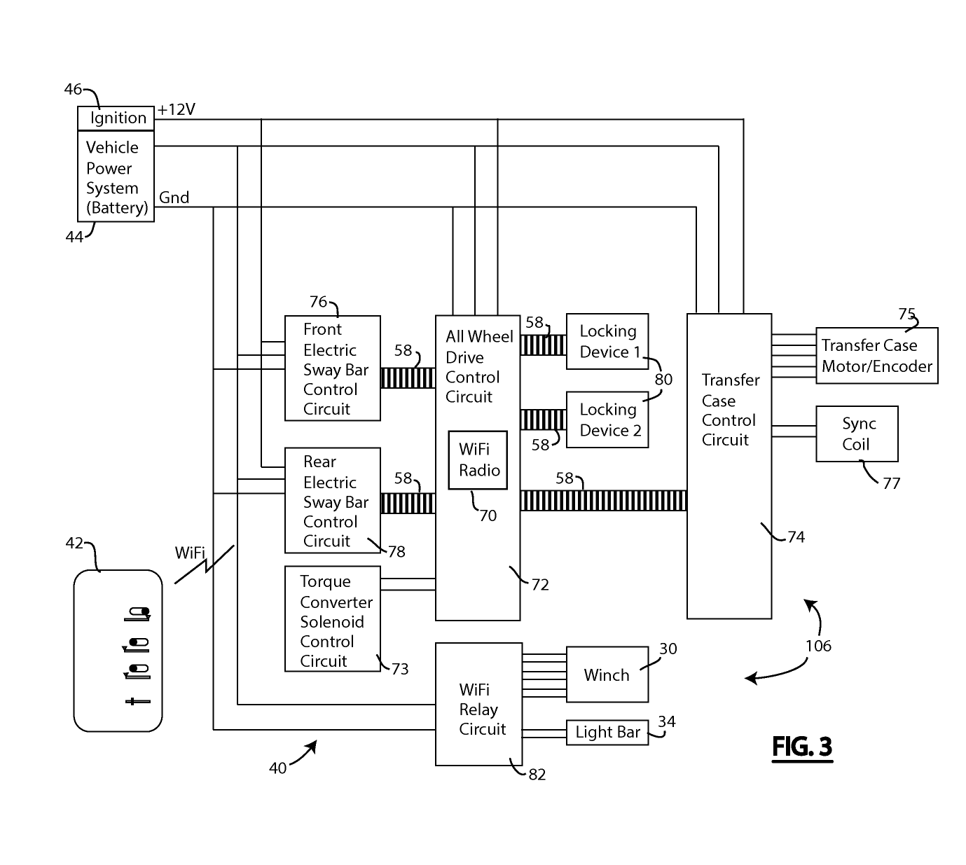

FIGS. 2 and 3 illustrate two different embodiments of the electronic control circuit and will now be described. Referring first to FIG. 2, the electronic control circuit 40 communicates with the portable personal electronic telecommunications device (portable device) 42 via wireless communication. In this embodiment the wireless communication utilizes Bluetooth radio frequency protocols to support communication. The embodiment of FIG. 3 uses WiFi radio frequency protocols. Of course, other wireless protocols, including infrared, Ultra Wideband (UWB), induction wireless and ZigBee® radio frequency are also suitable.

The electronic control circuit 40 is preferably deployed on a circuit board that can be mounted within the vehicle at a suitable location where access to one or more wiring harnesses is made available. Power for the electronic control circuit 40 is obtained from the vehicle power system 44, which provides a supply of DC electric power. The typical vehicle power system 44 includes a 12 volt battery and associated electronic equipment such as an alternator and voltage regulator that supplies electrical energy to charge the battery and to provide electrical power to components within the vehicle when the internal combustion engine is running. In a conventional vehicle power system, the alternator produces a nominal voltage of about 13.5 to 14.5 volts, which provides sufficient potential to charge the 12 volt battery. Electronic circuits coupled to such power system are typically designed to operate at a nominal 12 volts. In an all-electric vehicle the vehicle power system employs a larger, rechargeable battery system, and these systems may operate at a higher voltage, such as 42 volts, for example. When using such higher voltage power systems, voltage convertor circuits can be used to support circuits designed for 12 volt use.

The vehicle power system also includes an ignition circuit 46 that supplies a signal, such as a 12 volt DC signal, when switched on by the vehicle operator. Thus the illustrated vehicle power system 44 and optionally the ignition circuit 46 can be capable of providing electrical power to the electronic control circuit 40. The difference being that the vehicle power system 44 provides power at all times, whereas the ignition circuit 46 provides power only when the ignition circuit is switched on by the vehicle operator (by manipulating a key-operated or wireless key fob-operated ignition switch, for example). FIG. 2 shows how the various components of the electronic circuit 40 is coupled to the power system 44, the ignition circuit 46 and to the vehicle ground (Gnd).

The electronic control circuit 40 includes a processor circuit 48 that includes a main voltage regulator 50, used to condition the power supplied to the processor circuit 48 so that a steady nominal 12 volt DC power is available to power the microprocessor 52, the Bluetooth radio 54 and the vehicle bus transceiver 56. Microprocessor 52 is programmed to decode sensor signals and to supply control signals that are delivered over the vehicle bus. These signals include, for example, control signals that control actuators within the vehicle, including actuators used in connection with the vehicle powertrain, drivetrain and active suspension components. Although different vehicle bus architectures are possible, exemplary is the CAN bus architecture.

In the processor circuit 48 the Bluetooth radio circuit 54 provides communication between microprocessor 52 and the portable device 42. It is through this wireless communication that control functions associated with the vehicle actuators are off loaded to the microprocessor (not shown) within the portable device 42. Thus the user can control actuators that switch on and off and regulate various off-road performance-affecting (i.e., vehicle powertrain and/or drivetrain) components. The portable device 42 can also programmatically provide different drive and handling performance of the vehicle automatically, based on driver preferences or based on measured conditions or vehicle location using sensors (not shown) within the portable device. Such sensors within the portable device include, for example, GPS receivers, accelerometers, tilt sensors, temperature and barometric sensors, inertial sensors and the like. Programmatic control via the portable device may also be based on data signals provided from external data sources, such as cloud-based Internet sources, accessed using cellular telephone connectivity of the portable device.

The processor circuit 48 is in turn coupled via suitable vehicle bus or wiring harness connections 58 to a control module circuit 60 which may be implemented using electromechanical or solid state relays to control attached actuators, such as the illustrated locking devices 62 and auxiliary devices 64. The locking devices would be used, for example, to control physical operation of powertrain, drivetrain or active suspension subsystems within the vehicle. Examples of auxiliary devices 64 would include the winch 30, lift mechanism 32 and light bar 34 (FIG. 1).

As illustrated, the control module circuit 60 has its own bus connection 66 to the on-board diagnostic connection. Through this connection the states of devices attached to the control module circuit can be interrogated and made available to the on-board diagnostic system.

In effect, the processor circuit 48 and control module circuit 60 collectively act as a protocol convertor 106 that furnishes least one port by which to electrically couple to at least one actuator that supplies control to a powertrain component, drivetrain component, vehicle suspension component or vehicle accessory. In so doing, the protocol convertor 106 provides a communication channel by which communication is established with a portable personal electronic telecommunication device.

FIG. 3 shows a second embodiment of electronic control circuit 40 that is based on WiFi communication. As with the first embodiment, the second embodiment is coupled to the vehicle power system 44 and ignition circuit 46 as illustrated. In this embodiment the WiFi control capabilities are incorporated into the electronic control circuit 40, by inclusion of a WiFi radio 70 into a processor circuit such as the all-wheel drive control circuit 72. This control circuit 72, in turn, communicates with other processor circuits within the electronic control circuit 40 via the vehicle bus 58. Thus as illustrated the WiFi equipped control circuit 72 communicates over the vehicle bus with the transfer case control circuit 74, the front and rear electric sway bar control circuits 76 and 78, and with other bus enabled devices, such as locking devices 80.

As illustrated in FIG. 3, some devices that are not directly coupled to the vehicle bus may nevertheless be controlled by the electronic control circuit 40 because they are electrically connected (as by simple 12 volt power and signal lines) to subsystems that are coupled to the bus. Exemplary of these types of devices are the transfer case motor/encoder 75 and sync coil 77 coupled to the transfer case control circuit 74, and the torque converter solenoid control circuit 73 coupled to the all-wheel drive control circuit 72.

In other instances where a subsystem, powertrain component, drivetrain component, suspension component or vehicle accessory does not communicate over the vehicle bus, a separate wirelessly-enabled relay circuit 82 is provided. In the exemplary embodiment of FIG. 3, the wirelessly-enabled relay circuit 82 is coupled to electrically control the winch 30 and light bar 34 via simple 12 volt power and control lines. The wirelessly-enabled relay circuit 82 may be coupled to WiFi radio 70, to receive communication services from that radio, or the wirelessly-enabled relay circuit 82 may be equipped with its own wireless communication means, such as a WiFi radio. In some instances it will be more cost effective to share a common radio between the control circuit 72 and the relay circuit 82. In other instances, where these two circuits are more conveniently located in different locations within the vehicle, two separate radios may be preferred.

The electronic control circuit 40 communicates with the portable device 42 via WiFi signals that are transmitted and received between the WiFi radio within the portable device (not shown) and the WiFi radio or radios within the control circuit 40, such as WiFi radio 70.

Comparable to the embodiment of FIG. 2, the control circuits 72 and 74, together with the control circuits which they in turn control, and together with the WiFi relay circuit 82 all collectively act as a protocol convertor 106 that furnishes least one port by which to electrically couple to at least one actuator that supplies control to a powertrain component, drivetrain component, vehicle suspension component or vehicle accessory. In so doing, the protocol convertor 106 provides a communication channel by which communication is established with a portable personal electronic telecommunication device.

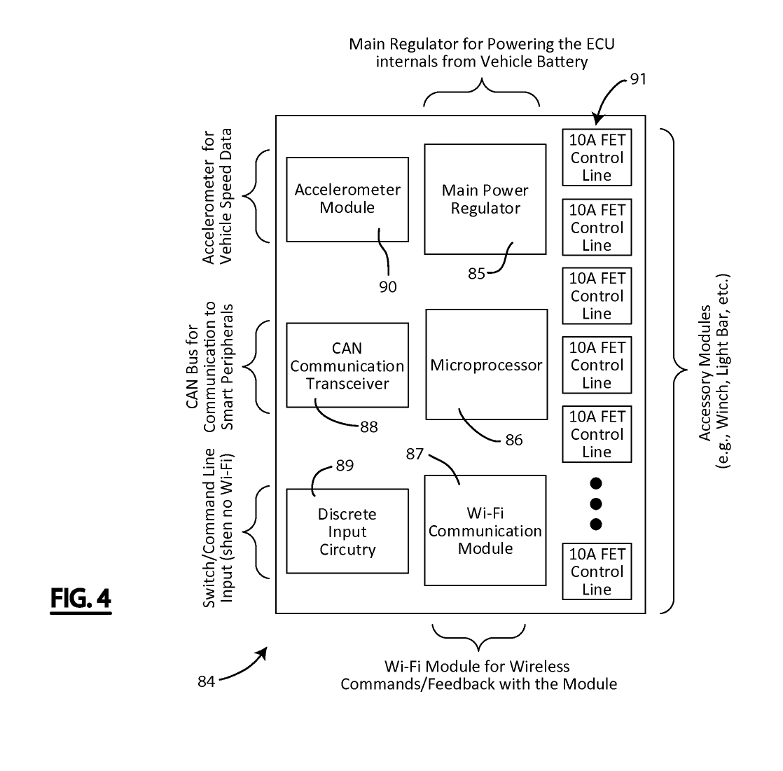

In a third embodiment, the functionality of protocol convertor 106 may be implemented as gateway circuit 84 shown in FIG. 4. Gateway circuit 84 is an electronic circuit that includes a main power regulator 85 that conditions power received from the vehicle's main regulator that powers the vehicle's engine control unit (ECU), which derives power in turn from the vehicle battery. The main power regulator 85 provides conditioned power to the other electronic circuits that make up the gateway circuit 84. The gateway control circuit 84 is preferably fixedly secured to the vehicle in a known orientation.

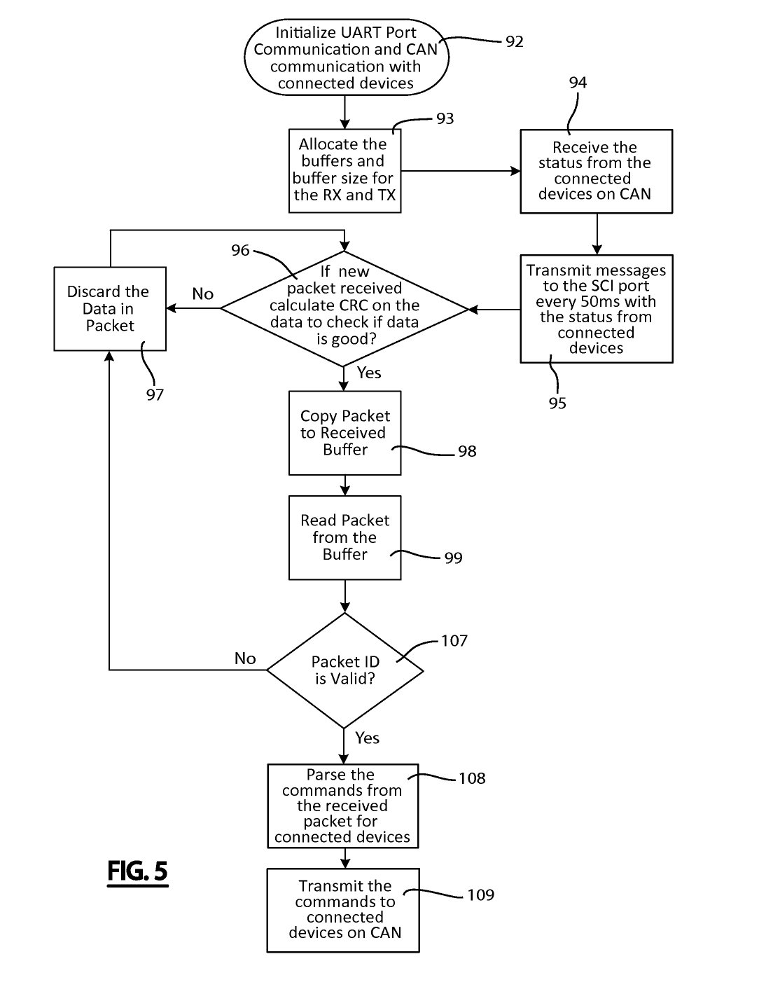

The gateway circuit further includes a microprocessor 86 that is programmed to pass communication signals among the various devices coupled to the gateway circuit 84. A further explanation of the programming of microprocessor 86 is discussed in connection with FIG. 5. The gateway circuit 84 also includes a WiFi communication radio transceiver circuit 87 that is coupled to the microprocessor 86 and handles the wireless communication by which the gateway circuit 84 communicates with the portable device 42.

The gateway circuit 84 is equipped with a vehicle bus communication transceiver circuit 88 (an example vehicle bus being the CAN bus). This transceiver circuit allows the microprocessor 86 to communicate with vehicle devices that are addressable via the vehicle bus. In this regard, the various actuators and sensors that make up the vehicular powertrain, drivetrain and suspension systems may be equipped with the ability to communicate over and thus are controlled by signals sent over the vehicle bus.

While it is expected that many vehicle devices will be bus-enabled, the gateway circuit 84 includes a block of discrete input circuitry 89 that allows the microprocessor 86 to communicate with (receive data signals from) a set of physical control switches or with the portable device 42 by wire interface cable when WiFi connectivity is not available. In this regard the wire interface cable to the portable device 42 can attach to the port normally used by the portable device for charging the battery of the portable device and for syncing the portable device with other computers.

In some instances, the gateway circuit 84 may pass to the microprocessor 86 sensor signals received from other systems within the vehicle, such as those supplied via the vehicle bus. In this way the microprocessor can be supplied with data indicating the current vehicle speed, for example. However, the gateway circuit 84 may also include its own sensors that can supply data to the microprocessor independent of what may be available elsewhere on the vehicle. To illustrate this concept, the gateway circuit 84 includes an accelerometer module 90, which is an electronic circuit that measures tilt and motion in both linear directions and rotational directions, depending on the configuration. Such data are used by the control logic to assist in determining the state of the vehicle, which may in turn be used to control various vehicular device control algorithms. For example, because the gateway control circuit 84 is fixedly secured to the vehicle in a known orientation, the accelerometer module 90 can provide an indication of the yaw, pitch and roll movement of the vehicle.

While modern vehicles typically include many devices that communicate over the vehicle bus, the gateway circuit 84 can also accommodate devices that are not bus-enabled. This functionality is provided by a bank of field effect transistor (FET) control line circuits 91 that each provide the capability of switching a nominal control voltage (e.g. 12 volt dc) on and off. The FET control line circuits 91 are controlled by microprocessor 86 and can be used to switch a variety of different devices on and off, and to control other voltage-controlled aspects of those devices. Examples of such devices include accessory modules, electric powered winches, light bars (for improved nighttime illumination) and the like.

FIG. 5 shows how the microprocessor and associated electronic components of the gateway circuit 84 are configured and programmed. When the gateway circuit 84 is first powered up, at step 92 the UART port (used to convert between parallel and serial communication) is initialized for communication with connected devices. At this same time the vehicle bus (CAN bus) is also initialized for communication with connected bus-enabled devices. The microprocessor 86 then, at step 93, allocates buffers for communication and establishes buffer size for handling transmit (TX) and receive (RX) operations. The status of the vehicle bus is then received, at step 94, from the connected devices on the vehicle bus and messages are transmitted to the serial communication interface (SCI) port periodically (e.g. every 50 ms) with the status from the connected devices.

Once these initial housekeeping matters are attended to, the microprocessor proceeds to handle communication traffic. Messages are sent over the vehicle bus in packets that are each encoded with a packet ID. To enhance reliability, messages sent over the vehicle bus are encoded with an error detection pattern, such as a cyclic redundancy check (CRC) code. The microprocessor, at step 96, checks each new packet as it is received to test whether the CRC code associated with the packet is correct for that packet. If the CRC check fails, the packet is discarded, at step 97 and control can loop back to step 96. If the packet passes the CRC check in step 96, it is copied by the microprocessor to the receive buffer, at step 98, whereupon the packet is then read from the buffer, at step 99 and tested, at step 107, to determine if the packet ID is valid. If the packet ID is invalid at step 107, control can proceed to step 97. If the packet ID is valid in step 107, control can pass the (valid) packets for parsing at step 108. Such parsing separates the commands received from the received packet according to which device the command corresponds. At step 109, the microprocessor transmits commands to the connected devices using the same packet protocol.

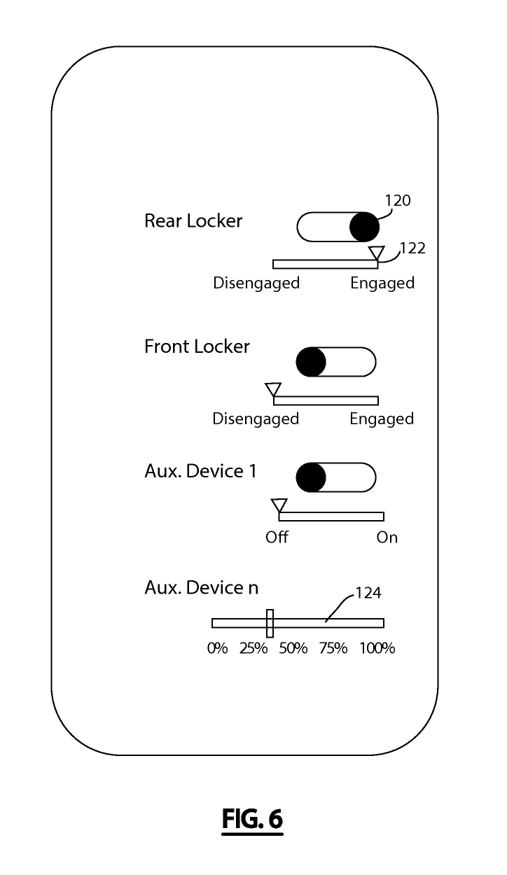

By way of illustration, FIG. 6 shows an exemplary user interface display on portable device 42, illustrating how the user can manipulate the portable device to effect control over various different vehicular actuators. In the illustrated example, the portable device 42, by virtue of the installed executable program (App), presents a user interface display that includes a plurality of slide switches (operated by swiping touch gesture) 120 below each of which is a graphical display 122 showing whether the state of the controlled vehicular actuator associated with that particular switch. If desired, the state of the actuator displayed at 122 can be based on signals received from the vehicle actuator (thus showing the true state of the device), alternatively the graphical display 122 can show the state of the switch 120, thereby providing additional meaning as to what the switch state represents.

While slide switches are one presently preferred user interface control, other options are possible. FIG. 6 illustrates one such other option, where a variable slider control 124 is presented. Using a swiping touch gesture to variably adjust the setting of the controlled device. In this case the user has set the device at a setting greater than 25% but less than 50%.

It will be appreciated that the embodiments of FIGS. 2 and 3 are merely intended as exemplary of what is possible using the disclosed technology. Thus while particular controlled vehicle components and their respective control circuits and bus connections have been illustrated, the principles of the disclosed technology can be utilized in a variety of other combinations of vehicle components.

Executable Program Run by Processor of Mobile Device

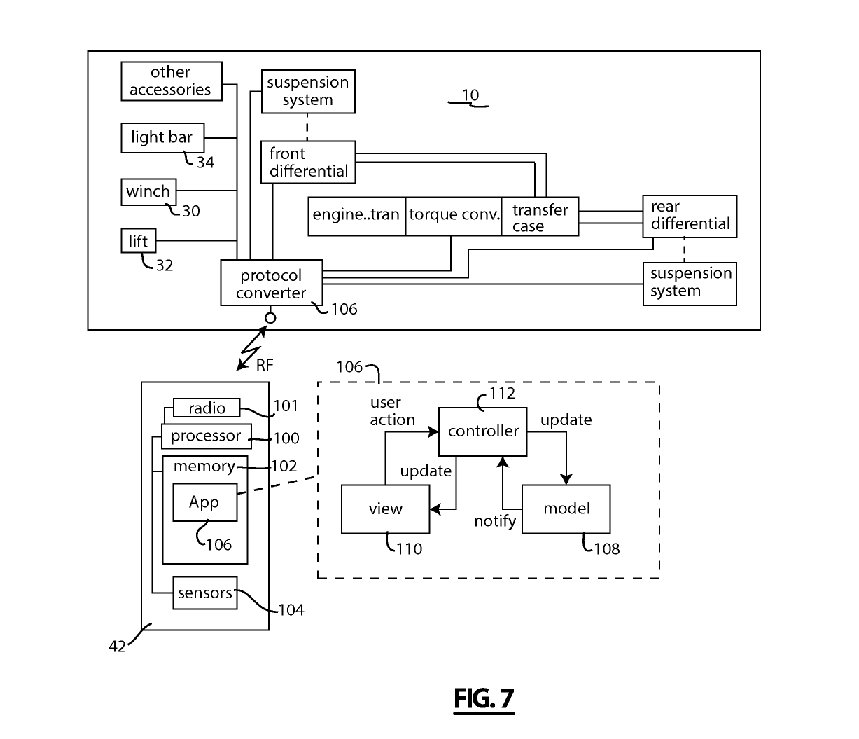

The portable device 42 has at least one internal processor 100 with attached processor-readable memory 102, as diagrammatically illustrated in FIG. 7. Also coupled to the processor are a diverse complement of sensors 104. Examples of such sensors include: GPS receiver, accelerometer sensors, inertial sensors, barometric pressure sensors, temperature sensors, tilt sensors, and the like. The portable device also includes a complement of different radios, including by way of example, cellular telephone, WiFi, Bluetooth, NFC (near-field communication) and the like. Thus the portable device is capable of receiving data from a source of data external to the vehicle, such as through a cloud service deployed on the internet.

As previously discussed, the portable device 42 communicates wirelessly with the protocol converter circuit 106 to effect wireless control over the many disparate vehicular subsystems that contribute to the overall driving performance and handling of the vehicle. These subsystems include those illustrated in FIG. 7, which can be categorized generally as belonging to the powertrain, drivetrain, vehicular suspension subsystems or otherwise categorized as accessories (e.g., winch, lift, light bar).

The executable program run by processor 100 may be configured as shown in FIG. 7 based on the model-view-controller architecture. It will be understood that the respective model 108, view 110 and controller 112 components of the software architecture are portions of executable code and associated data maintained by those portions, using object-oriented computer architecture techniques.

In this architecture the model 108 encapsulates the state data corresponding to the switch settings entered by the user and corresponding to other settings that are automatically set by operation of the program itself. The model is communicates with the controller 112, by providing notifications to the controller 112 of state changes arising from logic processing under the model's control and by receiving updates from the controller regarding changes requested by user interaction or based on other sensor data processed by the controller.

The controller 112 handles communication with the protocol converter 106 and thus sends and receives data that are sent via the wireless link to the protocol converter. The controller 112 is also responsible for managing the lifecycle of software objects instantiated during operation of the executable program.

The view 110 is responsible for providing the user with a visualization of the state of the model. The view 110 is thus responsible for generating the display screen shown in FIG. 6. Any user action, such as manipulation of slide switches 120 or variable slider controls 124, are passed to the controller 112, which then, in turn, updates the model 108. Information regarding the state of the model or regarding other information resident in the controller or model are updated to the view by the controller. Thus, if the controller is receiving temperature data from one of the controlled actuators, via the protocol converter 106, that information could be provided to the user through an appropriate update message from controller 112 to view 110. Similarly, if the state of the model changes, that information can be provided to the user through an appropriate notification message to the controller 112, which, in turn, provides an appropriate update message to the view 110.

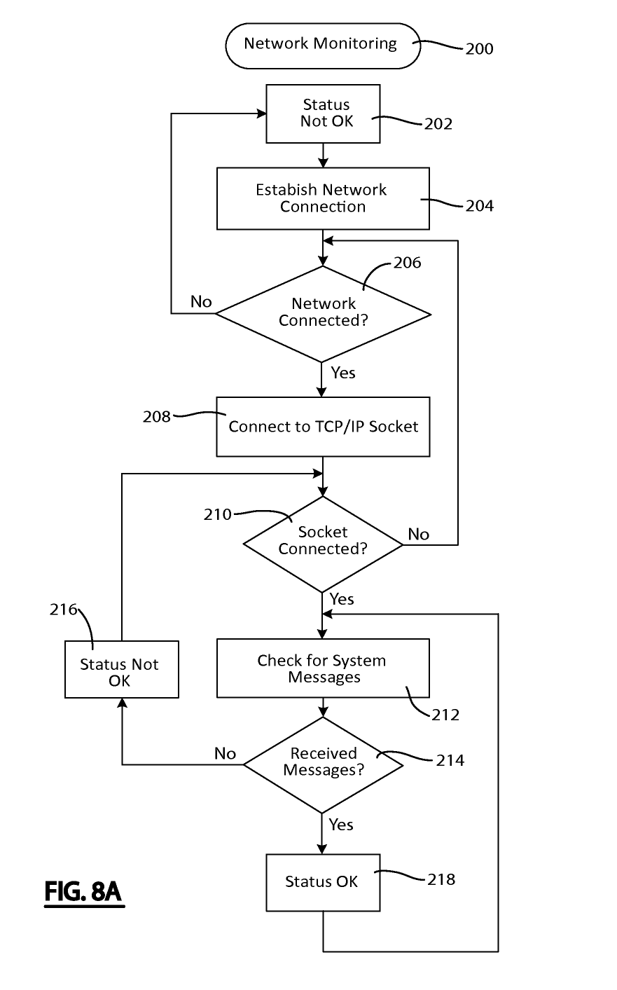

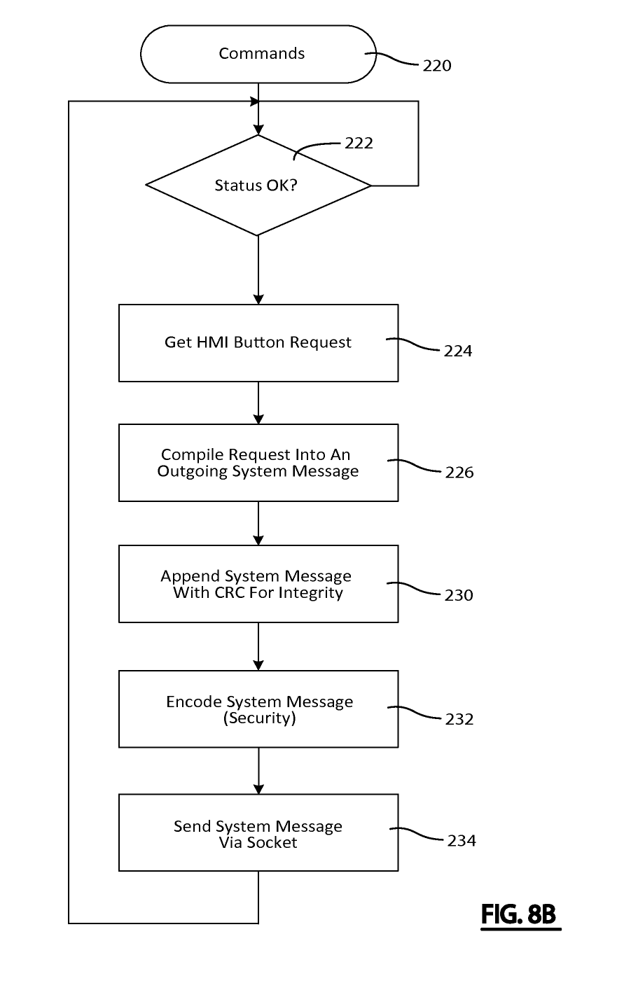

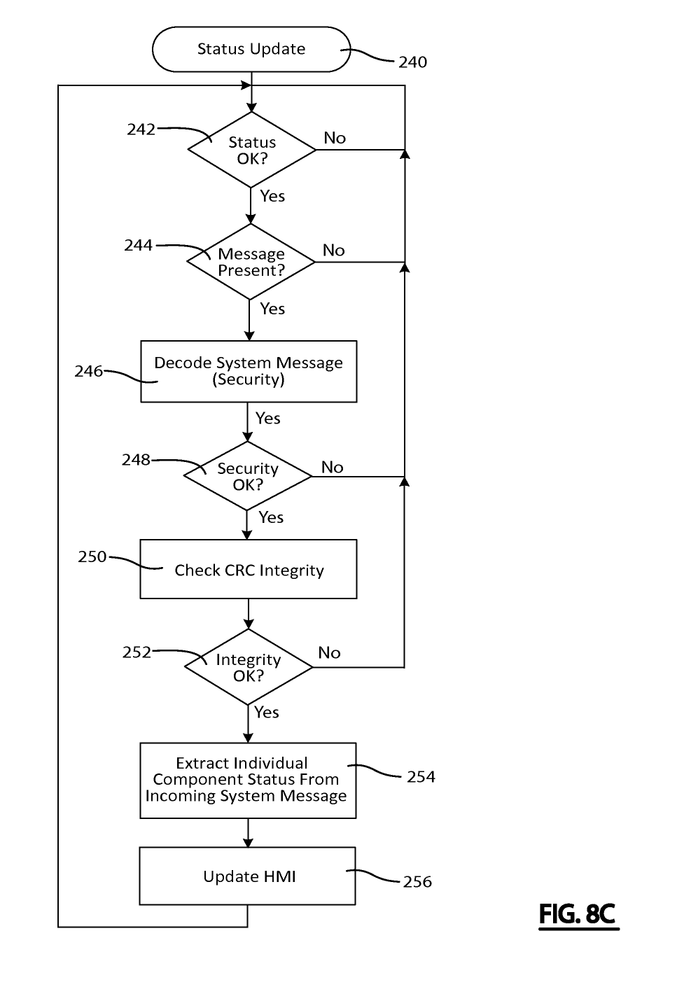

FIGS. 8A, 8B and 8C show in greater detail how the executable program stored in the memory circuit of the portable personal electronic telecommunication device is configured to provide the foregoing functionality. Specifically, FIG. 8A details how the processor is programmed to monitor the WiFi communication channel for network traffic and thereby place the processor 100 in communication with the protocol converter 106. FIG. 8B shows how the processor is programmed to respond to user commands entered via the human-machine interface (HMI) screen of the portable device. FIG. 8C shows how the processor is programmed to process messages sent via the WiFi communication channel (e.g., from the protocol converter).

With reference to FIG. 8A, the network monitoring routine 200 begins from an initial state, step 202, where the network status is not OK. This status persists until connection to the WiFi network is established. The executable program causes the portable device to attempt to establish network connection, step 204 and then test, at step 206, whether the network connection has been established. If a network connection is not established, the program loops back to the status not OK state 202 and the process repeats until a network connection is established.

Once network connection is established, the executable program causes the processor 100 to connect to the TCP/IP socket designated by the program. This TCP/IP socket thus serves as the port through which the processor will communicate with devices coupled to the protocol converter 106. If a socket connection cannot be established, at 201, the program loops back to step 206, allowing the processor 100 to recheck and reconnect to the WiFi network. Once the socket is connected, the program checks the incoming message stream for system messages at step 212. If system messages are not received, the program loops back to step 210 to again test whether a TCP/IP socket has been properly connected. Assuming system messages are being received at step 214, the program enters a Status OK state at 218. If desired a Status OK flag can be set at this point, whereupon the program branches back to step 212 to continue to check for system messages. If at any point system messages are not received, the program loops back to step 210 as discussed above.

Thus it can be seen that the executable program implements a nested series of steps that test and establish a network connection, test and establish a TCP/IP socket connection and then test and receive system messages sent over the network via the assigned socket connection.

With reference to FIG. 8B, the command processing routine 220 begins by checking whether the Status OK state persists, at step 222. This state was discussed in connection with FIG. 8a and will persist so long as the network connection has been established, the appropriate socket connection has been established, and system messages are being received.

Assuming the Status OK state is true, the program begins by harvesting any human-machine interface (HMI) input such as a button press entered via the screen of the portable device (as illustrated in FIG. 6). Next the program, at step 226, compiles a request based on decoding the user input (button press) into an outgoing system message. This can be accomplished, for example, by providing a stored lookup table in memory 102 that gives the corresponding system message associated with each different user input. In the case of simple button presses, this lookup table can be consulted directly to convert the button press into the corresponding outgoing system message. In more complex operations, the executable program performs additional processing steps, using the information stored in the lookup table, and then generates the outgoing system message.

For example, a more complex operation might involve using the current vehicle GPS location, obtained from the GPS receiver on board the portable device and then consulting a separate table that stores a set of one or more simple commands that have been associated with a stored GPS location. In this way, the current GPS location can be used to assemble a plurality of different simple (e.g. button press) commands that are then concurrently issued to effect a change in the settings of plural vehicle devices in harmony with one another.

Once the outgoing system message has been compiled, the program, at step 230, calculates a CRC code based on the compiled message and appends this code to the message. In this way the message can be checked for integrity by the protocol converter or by another processor or controller within the vehicle to ensure that the message was not garbled in transit.

Because the system messages are being sent wirelessly, a security mechanism is employed to prevent inadvertent or intentional interference by other third party devices that happen to be communicating on the same wireless channel. Clearly, the vehicle owner would not want his or her vehicle to be controlled by someone else who happens to be running the same application software on a portable device. Thus the program, at step 232, encodes the system message with using an encryption process, such as the Advanced Encryption Standard (AES) algorithm. The encrypted message is then sent via the socket at step 234.

With reference to FIG. 8C, the status update routine 240 begins at step 242 by checking whether the Status OK condition persists. This Status OK condition was discussed in connection with FIG. 8A. Assuming the Status OK state is true, the program checks to determine if a message is present, step 244, whereupon it decodes the message, step 246. This involves a series of steps where the security status of the message is first checked, at 248 and then the CRC integrity is checked, at 250 and 252. If the message passes security and integrity checks, the message is then parsed, at step 254, to extract individual component status from the incoming system message. For example, if the incoming system message contains the (on/off) status of the light bar 34, the on/off state is stored in a memory location within the portable device allocated for storing light bar status. The same procedure is used for each of the other controlled vehicle devices. With the state having been updated within memory 102, the program then updates the display on the HMI to reflect the current setting.

What is claimed is:

1. A kit for modifying a vehicle for off-road performance controllable by a portable personal electronic telecommunication device, comprising:
at least one powertrain, drivetrain or vehicle suspension component adapted for retrofit assembly into an automotive vehicle,
the at least one powertrain, drivetrain or vehicle suspension component being electrically actuable between at least a first operating state and a second operating state;
a protocol converter circuit coupled to receive electric power from an electrical power system of the automotive vehicle,
the protocol converter circuit having at least one port by which to electrically couple to said at least one powertrain, drivetrain or vehicle suspension component;
the protocol converter circuit providing a communication channel by which communication is established with a portable personal electronic telecommunication device;
an executable program stored in the memory circuit of the portable personal electronic telecommunication device and operable by the processor of the portable personal electronic telecommunication device to supply control signals via the protocol converter circuit to said at least one powertrain, drivetrain or vehicle suspension component.

2. The kit of claim 1 wherein the at least one powertrain, drivetrain or vehicle suspension component is selected from the group consisting of a front locking differential, a rear locking differential, a transfer case, a front disconnectable stabilizer bar and a rear disconnectable stabilizer bar.

3. The kit of claim 1 further comprising an electrically controllable accessory adapted to be carried by the automotive vehicle and having port for electrically coupling to said protocol converter.

4. The kit of claim 3 wherein the accessory is selected from the group consisting of electric winch and light bar.

5. The kit of claim 1 wherein the portable personal electronic telecommunication device is a smartphone or tablet computer.

6. The kit of claim 1 wherein the vehicle has an electronic message communication bus and wherein the at least one powertrain, drivetrain or vehicle suspension component is controllable by electronic messages sent over said bus.

7. The kit of claim 1 wherein the vehicle has an electronic message communication bus and wherein said protocol converter circuit is electrically coupled to said message communication bus.

8. A circuit for adapting at least one of the powertrain, drivetrain and vehicle suspension components of an automotive vehicle to be controlled by a portable personal electronic telecommunication device having memory and a processor, comprising:
a protocol converter circuit coupled to receive electric power from an electrical power system of the automotive vehicle,
the protocol converter circuit having at least one port by which to electrically couple to at least one actuator that supplies control to a powertrain, drivetrain or vehicle suspension component of the automotive vehicle;
the protocol converter circuit providing a communication channel by which communication is established with a portable personal electronic telecommunication device;
an executable program stored in the memory circuit of the portable personal electronic telecommunication device and operable by the processor of the portable personal electronic telecommunication device to supply control signals via the protocol converter circuit to said at least one actuator.

9. A circuit for controlling at least one of the powertrain, drivetrain and vehicle suspension components of an automotive vehicle to programmatically provide different drive and handling performance using a portable personal electronic telecommunication device having memory and a processor, comprising:
a protocol converter circuit coupled to receive electric power from an electrical power system of the automotive vehicle,
the protocol converter circuit having at least one port by which to electrically couple to at least one actuator that supplies control to a powertrain, drivetrain or vehicle suspension component of the automotive vehicle;
the protocol converter circuit providing a communication channel by which communication is established with a portable personal electronic telecommunication device;
an executable program stored in the memory circuit of the portable personal electronic telecommunication device and operable by the processor of the portable personal electronic telecommunication device to supply control signals via the protocol converter circuit to plural different actuators in harmony to programmatically provide different drive and handling performance of the vehicle.

10. A circuit for controlling at least one of the powertrain, drivetrain and vehicle suspension components of an automotive vehicle to programmatically provide different drive and handling performance using a portable personal electronic telecommunication device having memory, having a processor and having at least one inertial sensor or guidance sensor, comprising:
a protocol converter circuit coupled to receive electric power from an electrical power system of the automotive vehicle,
the protocol converter circuit having at least one port by which to electrically couple to at least one actuator that supplies control to a powertrain, drivetrain or vehicle suspension component of the automotive vehicle;
the protocol converter circuit providing a communication channel by which communication is established with a portable personal electronic telecommunication device;
an executable program stored in the memory circuit of the portable personal electronic telecommunication device and operable by the processor of the portable personal electronic telecommunication device to process signals from the at least one inertial or guidance sensor and supply control signals via the protocol converter circuit the at least one actuator based on said signals from the at least one inertial sensor or guidance sensor.

11. The circuit of claim 10 wherein said executable program uses the signals from the at least one inertial sensor or guidance sensor to calculate a vehicle speed signal and wherein said executable program uses the calculated vehicle speed signal to place at least one of the powertrain, drivetrain and vehicle suspension components of an automotive vehicle in a locked state.

12. A circuit for controlling at least one of the powertrain, drivetrain and vehicle suspension components of an automotive vehicle to programmatically provide different drive and handling performance using a portable personal electronic telecommunication device having memory, having a processor and having at least one inertial or guidance sensor, comprising:
a protocol converter circuit coupled to receive electric power from an electrical power system of the automotive vehicle,
the protocol converter circuit having at least one port by which to electrically couple to at least one actuator that supplies control to a powertrain, drivetrain or vehicle suspension component of the automotive vehicle and having at least one port by which to electrically couple to a vehicle powered sensor;
the protocol converter circuit providing a wireless communication channel by which wireless communication is established with a portable personal electronic telecommunication device;
an executable program stored in the memory circuit of the portable personal electronic telecommunication device and operable by the processor of the portable personal electronic telecommunication device to process signals from the at least one inertial or guidance sensor and supply control signals via the protocol converter circuit the at least one actuator based on said signals from the at least one inertial or guidance sensor and also based on said vehicle powered sensor.

13. A circuit for controlling at least one of the powertrain, drivetrain and vehicle suspension components of an automotive vehicle to programmatically provide different drive and handling performance using a portable personal electronic telecommunication device having memory, having a processor and having at least one inertial or guidance sensor, comprising:
a protocol converter circuit coupled to receive electric power from an electrical power system of the automotive vehicle,
the protocol converter circuit having at least one port by which to electrically couple to at least one actuator that supplies control to a powertrain, drivetrain or vehicle suspension component of the automotive vehicle and having at least one port by which to electrically couple to a vehicle powered sensor and having at least one port by which to electrically couple to a vehicle powered sensor;
the protocol converter circuit providing a wireless communication channel by which wireless communication is established with a portable personal electronic telecommunication device;
an executable program stored in the memory circuit of the portable personal electronic telecommunication device and operable by the processor of the portable personal electronic telecommunication device to process signals from the at least one inertial or guidance sensor and from the vehicle powered sensor: (a) to generate a first location datum, (b) to supply predefined control signals via the protocol converter circuit to the at least one actuator and (c) to store in said memory a record that associates said predefined control signals with the first location datum;
wherein the executable program is further operable by the processor to read from said memory the stored record that associates the predefined control signals with the first location datum and to use that stored record to supply additional control signals via the protocol converter circuit the at least one actuator.

14. The circuit of claim 13 wherein the executable program is further operated by the processor (a) to process signals from the at least one inertial guidance sensor to ascertain a location of the vehicle, (b) to use said ascertained location of the vehicle to retrieve from said memory a stored record associated with the first location datum, and (c) to use the retrieved stored record to supply control signals via the protocol converter circuit the at least one actuator.
